(19) United States
(12) Patent Application Publication
(10) Pub. No.: US 2004/0201838 A1
(43) Pub. Date: Oct. 14, 2004

(54) LCD defect identifying apparatus

(76) Inventors: Yu-Chou Lee, Shu Lin City (TW); Ting-Hui Lee, Tucheng City (TW); Chen-Hsien Wang, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/644,519

(22) Filed: Aug. 20, 2003

(30) Foreign Application Priority Data
Apr. 14, 2003 (TW) 92205812

(51) Int. Cl. G01N 21/00

(52) U.S. Cl. 356/237.2

(57) ABSTRACT

A defect identifying apparatus marks a defect location, obviating manual marking in the LCD manufacturing process. The defect identifying apparatus includes a microscope and a defect marker. The defect marker is fastened to a base of the microscope. The defect marker includes an ink jet and a support frame. The support frame is employed to fix the ink jet to the base of the microscope. The ink jet should be positioned between an objective lens and its focal plane so as to avoid scratching the LCD substrate.

### BACKGROUND OF THE INVENTION

1. Field of Invention

The present invention relates to a defect Identifying apparatus. More particularly, the present invention relates to a defect Identifying apparatus in the LCD manufacturing process.

2. Description of Related Art

The production yield of LCD monitors is critical to the manufacturing cost. High production yield not only reduces the manufacturing cost but also becomes an important index for comparison with competitors. High production yield lies in a high-quality manufacturing plant. The criteria for the high-quality manufacturing plant include well-trained technicians, discipline, well-maintained equipment and defect analysis.

Of all the criteria, defect analysis is the most effective way to improve the production yield. Conducting defect analysis can prevent yield loss due to the same cause. More particularly, defect analysis is favorable to a plant with hundreds of complicated manufacturing processes, such as semiconductor foundry fabrication, DRAM manufacturing and LCD (liquid crystal display) manufacturing. Some corporations even have a department in charge of all defect analyses.

Currently, defect inspection equipment 10 (as illustrated in FIG. 1) is employed to identify line defects or pixel defects on LCD glass substrate 12 disposed on a platform 14 in the manufacturing process thereof. When a defect is located, it needs to be marked manually by an engineer. Although defect inspection equipment includes a computer recording the location of defect, technicians can't recognize defect without marking. Thus, it takes a lot of time to relocate the defect and identify it with a marker after the LCD glass substrate is taken out. When a larger LCD glass substrate is processed, the glass substrate is too large to mark manually.

### SUMMARY OF THE INVENTION

The present invention is directed to an LCD defect identifying apparatus, satisfying a desperate need for accelerating defect marking.

It is therefore an objective of the present invention to provide an LCD defect identifying apparatus so as to enhance defect marking efficiency.

In accordance with the foregoing and other objectives of the present invention, a defect identifying apparatus functions to mark the defect location, obviating the need for manual marking in the LCD manufacturing process. The defect identifying apparatus includes a microscope and a defect marker. The defect marker is fastened to a base of the microscope. The defect marker includes an ink jet and a support frame. The support frame is employed to fix the ink jet to the base of the microscope. The ink jet should be positioned between an objective lens and its focal plane so as to avoid scratching the LCD substrate.

In general, the defect identifying apparatus can accelerate defect marking and analysis procedure. Defect analysis enhancement can contribute to yield improvement. In addition, the defect identifying apparatus can be manually operated or remotely controlled by a computer equipped with a software and inspection camera.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of a conventional LCD glass substrate defect inspection equipment;

FIG. 2 illustrates a perspective view of a defect identifying apparatus according to one preferred embodiment of this invention; and

FIG. 3 illustrates an enlarged detailed view of the area indicated by dashed circle 30 in FIG. 2 according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to enhance convenience for defect identifying, a defect identifying apparatus is installed on an inspection equipment. If there is need for identifying line defects or pixel defects on an LCD substrate, a defect identifying apparatus marks the defect right after inspection and then the LCD substrate can be sent immediately for analysis. The defect identifying apparatus can be controlled manually or by software operated by a computer.

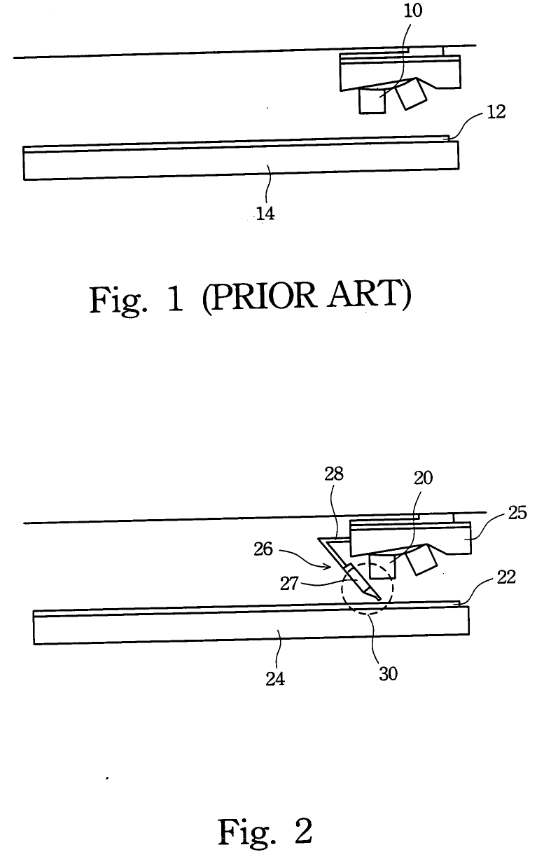

FIG. 2 illustrates a perspective view of a defect identifying apparatus according to one preferred embodiment of this invention. The difference between conventional inspection equipment (illustrated in FIG. 1) and the defect identifying apparatus of present invention is the defect marker 26. The defect marker 26 is installed on a base 25. The defect marker 26 includes a support frame 28 and an ink jet 27. The support frame 28 functions to fasten the ink jet 27 to the base 25.

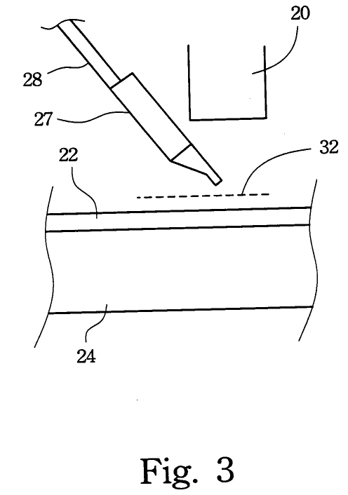

FIG. 3 illustrates an enlarged detailed view of the area indicated by dashed 30 in FIG. 2 according to one preferred embodiment of this invention. The ink jet 27 can pour a jet of ink on defect position rapidly right after inspection is concluded. The objective lens is adjusted up and down while searching for focal plane 32. The tip of ink jet 27 is positioned between objective lens 20 and its focal plane 32 such that the tip can avoid scratching LCD substrate 22 disposed on a platform 24.

Referring FIG. 2 again, the defect identifying procedure begins with searching for and inspecting a defect location. The next step is marking the defect location by means of ink jet 27, during which time the defect can be viewed clearly by the objective lens 20. In practice, ink jet 27 can be manually operated if the LCD glass substrate 22 is smaller, such as a third-generation LCD with a size of 550 mm×670 mm. Because the LCD glass substrate 22 is smaller, the distance between inspection camera (not illustrated in FIG. 2) and objective lens 20 is shorter. If the LCD glass substrate 22 is larger, such as a fifth-generation LCD with a size of 1100 mm×1300 mm, the distance between the inspection camera (not illustrated in FIG. 2) and objective lens 20 is larger. Thus, ink jet 27 may be operated by means of software installed in a computer equipped with inspection camera.

According to the preferred embodiment of preferred invention, the defect identifying apparatus can accelerate the defect marking and analysis procedure. Defect analysis enhancement can contribute to yield improvement. In addition, the defect identifying apparatus can be manually operated or remotely controlled by a computer equipped with software and inspection camera.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A defect identifying apparatus, for inspecting and locating defects on an LCD substrate, said defect identifying apparatus comprising:
a microscope, including at least one objective lens and a base;
a defect marker fixed to said base, wherein said defect marker locates a defect.

2. The defect identifying apparatus of claim 1, wherein said defect marker further includes a marking tip positioned between said objective lens and a focal plane of said objective lens.

3. The defect identifying apparatus of claim 1, wherein said defect marker further includes an ink jet.

4. A defect identifying apparatus, for inspecting and locating defects on an LCD substrate, said defect identifying apparatus comprising:
an inspection apparatus, including a base;
a defect marker fixed to said base, said defect marker including an ink jet, wherein said ink jet marks a defect.

5. The defect identifying apparatus of claim 4, wherein said inspection apparatus is a microscope.

6. The defect identifying apparatus of claim 5, wherein said microscope further includes an objective lens.

7. The defect identifying apparatus of claim 6, wherein said ink jet is positioned between said objective lens and a focal plane of said objective lens.
